(19) United States
(12) Patent Application Publication
(10) Pub. No.: US 2001/0040726 A1
(43) Pub. Date: Nov. 15, 2001

(54) Microscope

(75) Inventor: Ulrich Sander, Rebstein (CH)

Correspondence Address: SIMPSON, SIMPSON & SNYDER, PLLC, 5555 MAIN STREET, WILLIAMSVILLE, NY, 14221-5406, US

(73) Assignee: Leica Microsystems AG, Heerbrugg (CH)

(21) Appl. No.: 09/847,632

(22) Filed: May 2, 2001

(30) Foreign Application Priority Data
May 8, 2000 (CH) 0977/00

(51) Int. Cl. G02B 21/00

(52) U.S. Cl. 359/387; 359/368; 359/381; 359/385

(57) ABSTRACT

The invention concerns a microscope having an illumination beam path, in which a darkening of the illumination on the subject (21) is achieved by removing, or changing the position of, an optical component.

### CROSS-REFERENCE TO RELATED APPLICATIONS

This invention claims priority of the Swiss patent application 0977/00 filed May 8, 2000 which is incorporated by reference herein.

### FIELD OF THE INVENTION

The invention concerns a microscope having an apparatus for reducing the illumination intensity of the microscope illumination at a pupil of a patient while an eye is being viewed through the microscope, the illumination beam path remaining directed onto the patient's eye but not causing any absolute darkening.

### BACKGROUND OF THE INVENTION

In order to reduce a potential danger to a patient's eye, the light intensity at the eye being operated on is reduced during pauses in surgery. In practice, this is done by covering the eye with one's hand or with a stop that can be pivoted into the illumination beam path and is imaged onto the pupil of the patient's eye, so that the pupil is shaded by the stop. Such systems are also, inter alia, known as so-called “eclipse filters.”

Many illumination apparatuses of this kind, of various designs, have become known, for example DE-U-9103433.7 and U.S. Pat. No. 4,715,704.

DE 3339172 C2 describes a complete stop assemblage. Systems with black-dot darkening devices have been disclosed in DE-AS-1951139. DE-A-2654505 discloses two annular stops in an intermediate image plane of the illumination system, the images of these stops being created in the vicinity of the iris on the lens of eye. DE-U-9301448 describes a comparable stop device having a semitransparent light filter for the same purpose.

All the known assemblages thus assume that for darkening purposes, something must be introduced into the beam path in order to relieve stress on the patient's eye.

With the known assemblages, in order to achieve the corresponding imaging effects of the stops, these additionally introduced elements are arranged in the vicinity of the light source or in the vicinity of the light inlet into the system. This results in concentrated heat problems at that point. Because of the high light output in the region of the light source or the light inlet (e.g. from a light guide), considerable heating of the stop occurs. If the light output is present for a sufficiently long period, this can even result in destruction of the stop.

Leaving this aside, the stop also converts heat from the light radiation and emits it into the microscope interior, so that partial heating can occur there as well. Unpleasant light reflections are also disadvantageous.

A further disadvantage occurs, in the case of complete stops, from the fact that the pupil region is completely darkened and a great difference in brightness thus occurs between the illuminated and darkened state. The result of this, in some circumstances, is that details which the surgeon would like to recognize in the region of the pupil even during pauses in surgery are no longer sufficiently illuminated. The last-mentioned DE-U-9301448 provides some remedy here, but requires for the purpose the relatively costly filter which, on the other hand, once again brings about the aforesaid heating.

### SUMMARY OF THE INVENTION

It is the object of the invention to create a new, improved system which on the one hand reduces heating in the usual stop region and on the other hand does not require complex filters for darkening.

This object is achieved by a microscope as defined by the features of Claim 1, and by a method as defined by the features of Claim 5.

The removal of an optical component, such as a lens, from the beam path annuls the intended function of that component. Since all the optical components in the beam path usually serve to collimate or focus the light, the removal according to the present invention results in diffuse scattering of the light, the effect being a definite darkening of the light intensity in the endangered region.

“Removal of an optical component” is also to be understood, for purposes of the invention, as removal of a complete assembly of different components, or also as the displacement or pivoting thereof, so that the function of focusing or collimating the light radiated through that assembly no longer exists.

The remaining diffused illumination will nevertheless still cast sufficient light through the illumination beam path toward the patient's eye that the surgeon or ancillary personnel will still have sufficient illumination for simply observing the surgical location.

The invention is not limited to problems of ophthalmic surgery, but rather can be used in the field of microscopy wherever illumination intensity needs to be reduced with no change in the light output of the light source. Consistency of color temperature is thus guaranteed.

The dependent claims describe and protect further improvement actions. An exemplary embodiment of the invention is presented in the drawings and the description pertaining to the Figures.

Further improvements and details according to the present invention are evident from the drawings and their description.

### BRIEF DESCRIPTION OF THE DRAWINGS

The Figures are described in linked fashion. Identical components have identical reference characters. Components of similar function have identical reference characters with different indices. In the drawings:

FIG. 1 shows an assemblage with light introduced via a light guide and collector and zoom lenses and prisms; one of the collector lenses is mechanically removable; additionally or alternatively, one of the lenses at the prism is removable;

FIG. 2 shows an assemblage comparable to FIG. 1, where instead of removal of a zoom lens, the prism can be laterally pivoted out or pulled out;

FIG. 3 shows an assemblage in which the entire illumination optical system is axially displaceable into a defocused position.

### DETAILED DESCRIPTION OF THE INVENTION

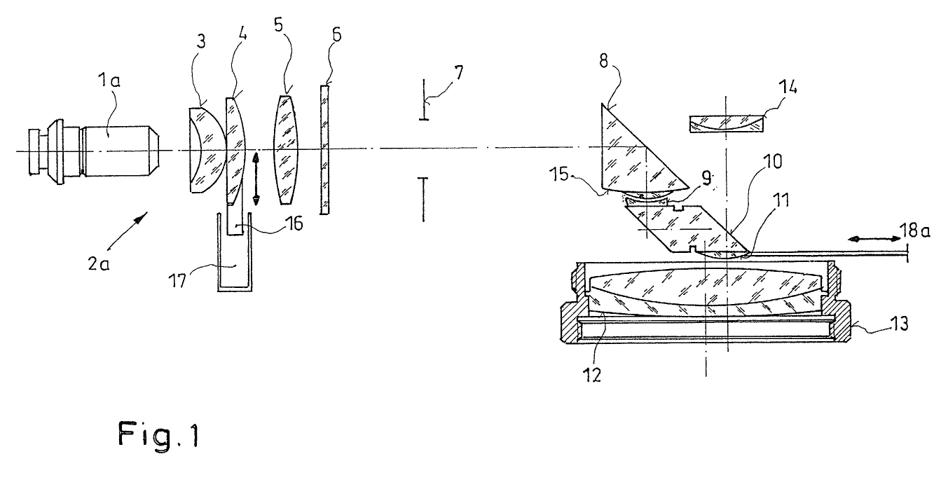

FIG. 1 shows the end of a light guide la which is followed by an assembly 2a of optical elements for illumination, collimation and focusing. Assembly 2a comprises, for example, a collector lens 3, a further collector lens 4, a zoom lens 5, and a UV filter 6.

These are followed in the illumination beam by a stop 7, a mirror prism 8 having a convex light exit surface 15, a concave lens 9, a stepped mirror prism 10 having a convex lens 11, and a main objective 12 that is held in an objective mount 13.

Additionally or alternatively, convex lens 11 is configured to be removable, i.e. to be pivoted out or pulled out as shown by arrow 18a. If the convex lens is not removable (as is preferred in some circumstances), it can also be cemented to prism 10.

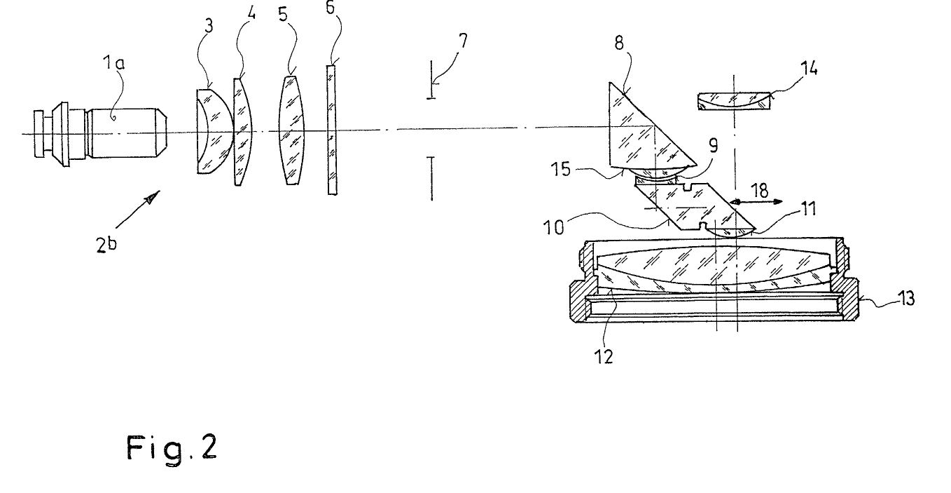

FIGS. 1 and 2 also indicate a tube lens 14 which is associated with the observation beam path.

What is special and novel about this assemblage is that collector lens 4 is removable from assembly 2a by means of a mechanism that is only symbolically depicted. A mount 16 carrying collector lens 4 is joined to a handle or motorized drive (not depicted), and can be displaced in a guide so that it is absent from assembly 2a and its function is eliminated.

The resulting effect is that what emerges from assembly 2a is only more-diffuse light, which in coaction with the refracting surfaces on convex exit surface 15 and with lenses 9 and 11 in combination with the main objective, in turn allows only a defocused, attenuated light on the subject.

In the case of the assemblage shown in FIG. 2, assembly 2b remains stationary, but for darkening purposes the light-concentrating optical system with lenses 9 and 11 is pulled out laterally (as indicated by arrow 18) by means of mechanical grasping means that are not shown in detail. Instead of pulling out, pivoting out is also conceivable as an alternative. Prism 10 can remain in place in this context, or optionally can also be displaced or pivoted. What is important for the invention is the change in light quality toward maintaining a certain illumination but without collimation in the critical region of the patient's eye, by removal of a light-collimating component.

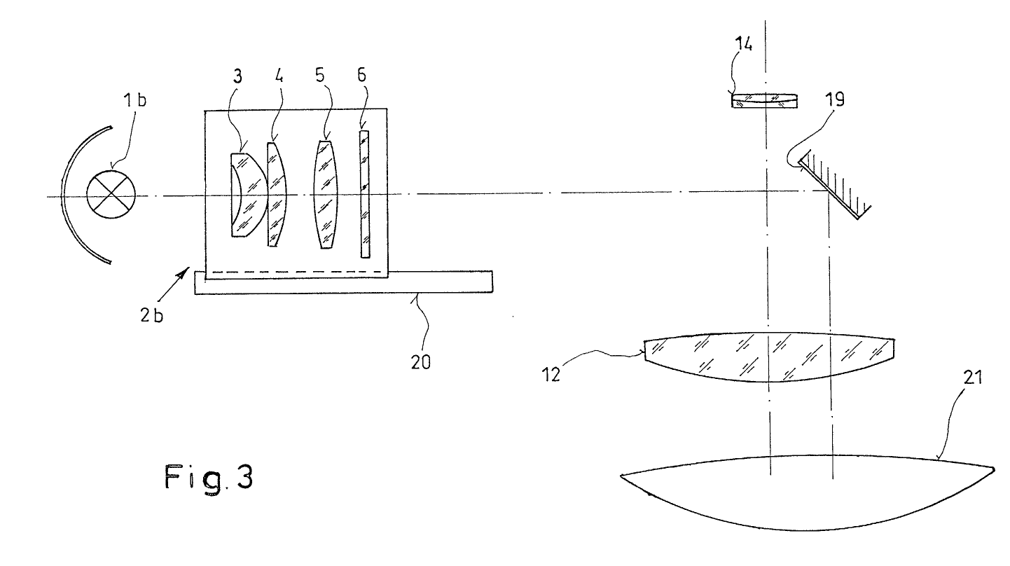

In the variant shown in FIG. 3, instead of removal of a component, assembly 2b is displaced (with means not depicted in detail) in a guide 20 along the illumination beam path, so as thereby to create defocusing or diffusion for darkening.

A wide variety of further alternatives is conceivable in the context of the invention; common to all of them is the fact that an additional element is not added, but rather an existing element is removed, or its position is changed, so as thereby correspondingly to modify the light beam path. For example, mirror 19 in FIG. 3 could be pivoted or displaced in such a way that the light is no longer incident in focused fashion on subject 21.

Parts List

1a Light guide

1b Lamp

2a, b Assembly of optical elements

3 First collector lens

4 Second collector lens

5 Zoom lens

6 UV filter

7 Stop

8 Mirror prism

9 Concave lens

10 Stepped mirror prism

11 Convex lens

12 Main objective

13 Objective mount

14 Tube lens

15 Convex exit surface

16 Mount

17 Guide

18, 18a Arrow

19 Mirror

20 Guide

21 Subject

What is claimed is:

1. In a microscope having an illumination device for illuminating the subject by directing light along an illumination beam path through a main objective of said microscope or in a region of a main objective of said microscope, and a plurality of optical components in said illumination beam path, the improvement comprising:
a mechanism for moving at least one of said plurality of optical components so that a darkening occurs at the subject because of the movement of said at least one optical component.

2. The improvement according to claim 1, wherein said mechanism removes said at least one optical component from said illumination beam path.

3. The improvement according to claim 1, wherein said mechanism changes the position of said at least one optical component in said illumination beam path.

4. The improvement according to claim 2, wherein said plurality of optical components includes a collector lens, and said mechanism includes a manually operable drive system for removing said collector lens from said illumination beam path.

5. The improvement according to claim 2, wherein said plurality of optical components includes a collector lens, and said mechanism includes an electromechanically operable drive system for removing said collector lens from said illumination beam path.

6. The improvement according to claim 2, wherein said plurality of optical components includes a mirror prism and a light-concentrating optical system fixed thereto for conveying illuminating light through said main objective, and said mechanism removes at least a portion of said light-concentrating optical system from said illumination beam path.

7. The microscope according to claim 6, wherein said mechanism pulls said at least a portion of said light-concentrating optical system from said illumination beam path.

8. The microscope according to claim 6, wherein said mechanism pivots said at least a portion of said light-concentrating optical system out of said illumination beam path.

9. The microscope according to claim 1, wherein said plurality of optical components includes an assembly of optical elements in said illumination beam path, and said mechanism removes said assembly from said illumination beam path.

10. The microscope according to claim 1, wherein said plurality of optical components includes an assembly of optical elements in said illumination beam path, and said mechanism displaces said assembly along said illumination beam path.

11. A method for darkening an illuminated subject under a microscope having an illumination device with an integrated illumination beam path in which a plurality of optical components are arranged, said method comprising the step of:
moving at least one of said plurality of optical components so that a darkening occurs at the subject because the movement of said at least one optical component causes light to arrive at the subject in a more diffuse or defocused fashion.

12. The method according to claim 11, wherein said step of moving at least one of said plurality of optical components comprises removing a collector lens from said illumination beam path.

13. The method according to claim 11, wherein said step of moving at least one of said plurality of optical components comprises removing at least a portion of a light-concentrating system from said illumination beam path.

14. The method according to claim 11, wherein said step of moving at least one of said plurality of optical components comprises pivoting a mirror.

15. The method according to claim 11, wherein said step of moving at least one of said plurality of optical components comprises displacing an assembly of optical elements along said illumination beam path.
